(19) United States
(12) Patent Application Publication
(10) Pub. No.: US 2008/0018649 A1
(43) Pub. Date: Jan. 24, 2008

(54) METHODS AND APPARATUSES FOR UTILIZING AN APPLICATION ON A REMOTE DEVICE

(76) Inventors: Zheng Yuan, San Jose, CA (US); Matthew Sheppard, Campbell, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/753,821

(22) Filed: May 25, 2007

Related U.S. Application Data
(63) Continuation-in-part of application No. 11/458,236, filed on Jul. 18, 2006.

(51) Int. Cl. G06T 11/20

(52) U.S. Cl. 345/440

(57) ABSTRACT

In one embodiment, the methods and apparatuses display a list representing a plurality of applications; view a status of each of the plurality of applications; view a target application as an available application from the plurality of applications; and remotely access the target application on a local device.

### RELATED APPLICATION

The present invention is a continuation-in-part of U.S. patent application Ser. No. 11/458,236 filed on Jul. 18, 2006 entitled “Methods and Apparatuses For Accessing an Application on a Remote Device”, which is incorporated herein by reference.

### FIELD OF INVENTION

The present invention relates generally to accessing an application and, more particularly, to accessing an application on a remote device.

### BACKGROUND

Systems to control a remote device located in a different location are utilized by many people. In controlling the remote device from a different location, a user is able to perform tasks on the remote device such as perform modifications to the remote device, view content accessible on the remote device, and the like without having physical access to the remote device.

### SUMMARY

In one embodiment, the methods and apparatuses display a list representing a plurality of applications; view a status of each of the plurality of applications; view a target application as an available application from the plurality of applications; and remotely access the target application on a local device.

### BRIEF DESCRIPTION OF THE DRAWINGS

The accompanying drawings, which are incorporated in and constitute a part of this specification, illustrate and explain one embodiment of the methods and apparatuses for utilizing an application on a remote device. In the drawings, FIG. 1 is a diagram illustrating an environment within which the methods and apparatuses for utilizing an application on a remote device are implemented;

FIG. 2 is a simplified block diagram illustrating one embodiment in which the methods and apparatuses for utilizing an application on a remote device are implemented;

FIG. 3 is a simplified block diagram illustrating a system, consistent with one embodiment of the methods and apparatuses selectively controlling a remote device;

FIG. 4 is an exemplary record for use with the methods and apparatuses for utilizing an application on a remote device;

FIG. 5 is a flow diagram consistent with one embodiment of the methods and apparatuses for utilizing an application on a remote device;

FIG. 6 is a flow diagram consistent with one embodiment of the methods and apparatuses for utilizing an application on a remote device;

FIG. 7 is a flow diagram consistent with one embodiment of the methods and apparatuses for utilizing an application on a remote device;

FIG. 8 is a flow diagram consistent with one embodiment of the methods and apparatuses for utilizing an application on a remote device; and

FIG. 9 is a flow diagram consistent with one embodiment of the methods and apparatuses for utilizing an application on a remote device.

### DETAILED DESCRIPTION

The following detailed description of the methods and apparatuses for utilizing an application on a remote device refers to the accompanying drawings. The detailed description is not intended to limit the methods and apparatuses for utilizing an application on a remote device. Instead, the scope of the methods and apparatuses for utilizing an application on a remote device is defined by the appended claims and equivalents. Those skilled in the art will recognize that many other implementations are possible, consistent with the present invention.

References to a device include a desktop computer, a portable computer, a personal digital assistant, a video phone, a landline telephone, a cellular telephone, and a device capable of receiving/transmitting an electronic signal.

In one embodiment, the methods and apparatuses for utilizing an application on a remote device allow a user to view a list of devices. Further, the user is capable of selectively accessing these listed devices. In one embodiment, the user is associated with a corresponding profile that identifies the devices within the list. Further, the status of each of the listed devices is shown.

In one embodiment, the listed devices have a profile associated with each device. In one embodiment, each of the devices have restrictions on the user accessing the device. In one embodiment, there are assigned rights that restrict the type of access that is allowed by the device. In another embodiment, access to the device is restricted by other factors such as the identity of the user, the particular device that the user utilizes to gain access, the number of times the user gains access, and the duration that the user accesses the device.

In yet another embodiment, access to the device is restricted to selected application(s). For example, if the selected application is Microsoft Excel®, then any document that is capable of being viewed through Excel® can be accessed through this particular device.

FIG. 1 is a diagram illustrating an environment within which the methods and apparatuses for utilizing an application on a remote device are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., a keypad, a video display screen, input and output interfaces, etc., in the same housing such as a personal digital assistant). In other embodiments, one or more user interface 115 components (e.g., a keyboard, a pointing device such as a mouse, a trackball, a microphone, a speaker, a display, a camera, etc., are physically separate from, and are conventionally coupled to, the electronic device 110. In one embodiment, the user utilizes interface 115 to access and control content and applications stored in electronic device 110, server 130, or a remote storage device (not shown) coupled via network 120.

In accordance with the invention, embodiments of selectively controlling a remote device below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

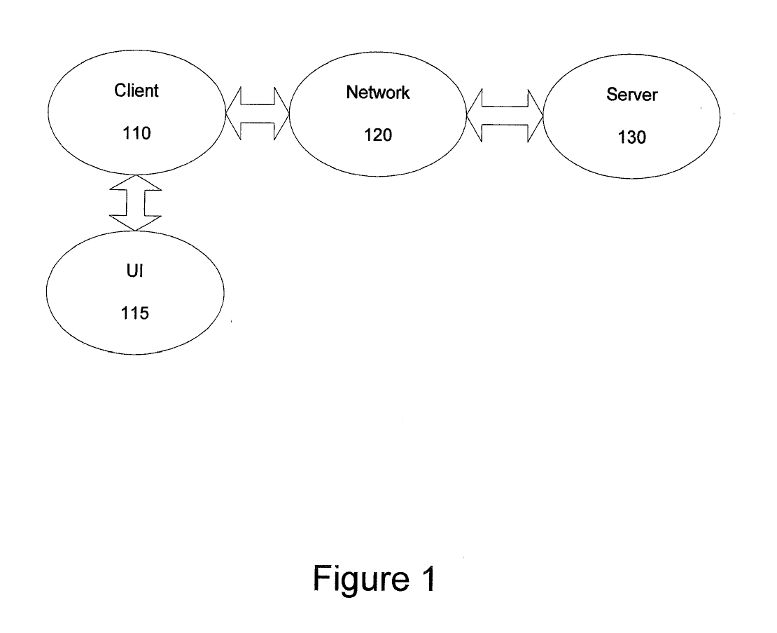

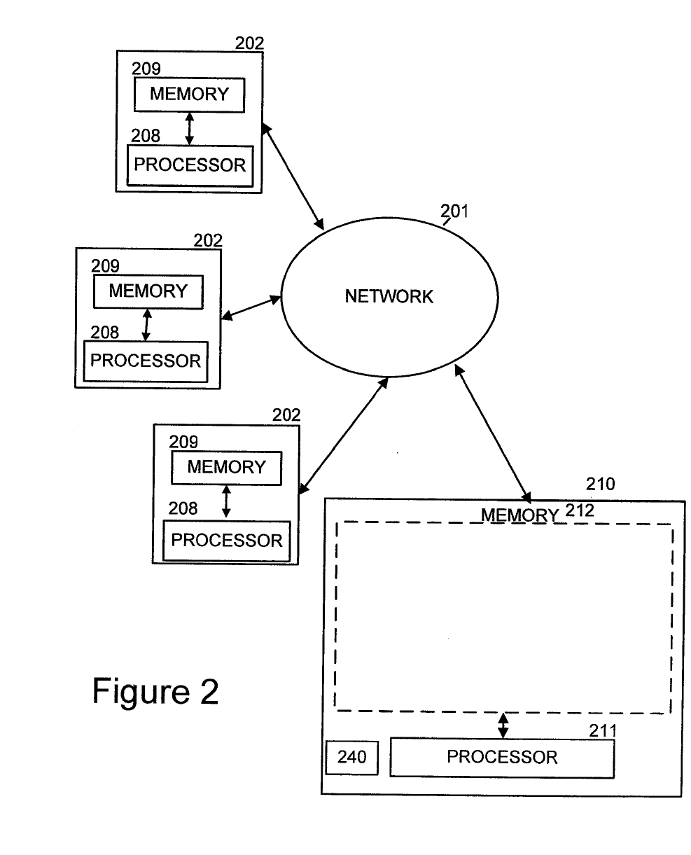

FIG. 2 is a simplified diagram illustrating an exemplary architecture in which the methods and apparatuses for utilizing an application on a remote device are implemented. The exemplary architecture includes a plurality of electronic devices 202, a server device 210, and a network 201 connecting electronic devices 202 to server 210 and each electronic device 202 to each other. The plurality of electronic devices 202 are each configured to include a computer-readable medium 209, such as random access memory, coupled to an electronic processor 208. Processor 208 executes program instructions stored in the computer-readable medium 209. In one embodiment, a unique user operates each electronic device 202 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 202 and the server 210 include instructions for a customized application for communicating between messaging and telephony systems. In one embodiment, the plurality of computer-readable media 209 and 212 contain, in part, the customized application. Additionally, the plurality of client devices 202 and the server 210 are configured to receive and transmit electronic messages for use with the customized application. Similarly, the network 210 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on selectively controlling a remote device as determined using embodiments described below.

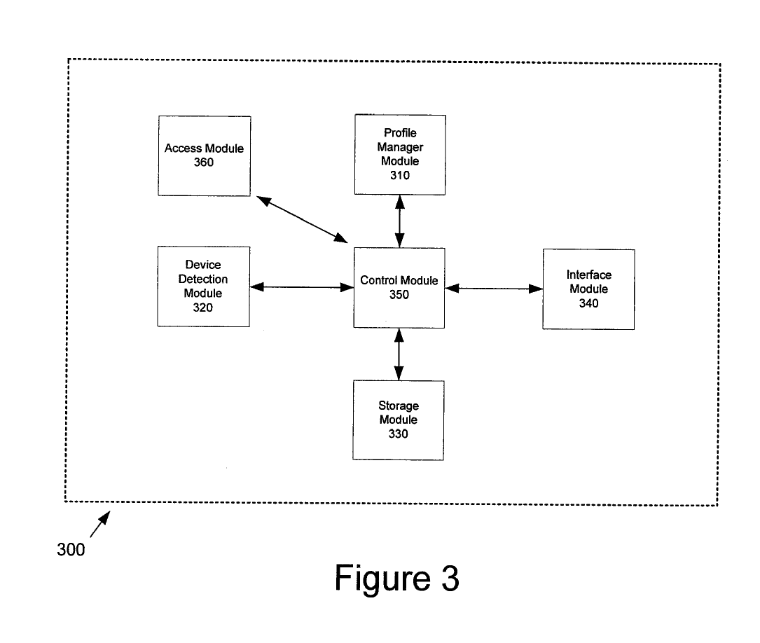

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a profile manager module 310, a device detection module 320, a storage module 330, an interface module 340, a control module 350, an access module 360, and an application permission module 370.

In one embodiment, the control module 350 communicates with the profile manager module 310, the device detection module 320, the storage module 330, the interface module 340, the control module 350, the access module 360, and the application permission module 370. In one embodiment, the control module 350 coordinates tasks, requests, and communications between the profile manager module 310, the device detection module 320, the storage module 330, the interface module 340, the control module 350, the access module 360, and the application permission module 370.

In one embodiment, the profile manager module 310 organizes and tracks the profiles. In one embodiment, each profile corresponds to a device. In another embodiment, each profile corresponds with a user.

In one embodiment, the device detection module 320 detects and identifies the identity of the devices. In one embodiment, the device detection module 320 detects the identity of devices that are coupled to a network such as an intranet, the Internet, a LAN, a WAN, and the like. The network may include both wired and wireless networks.

In another embodiment, the device detection module 320 also detects the status of the device. A device status includes being available, busy, logged off, and the like.

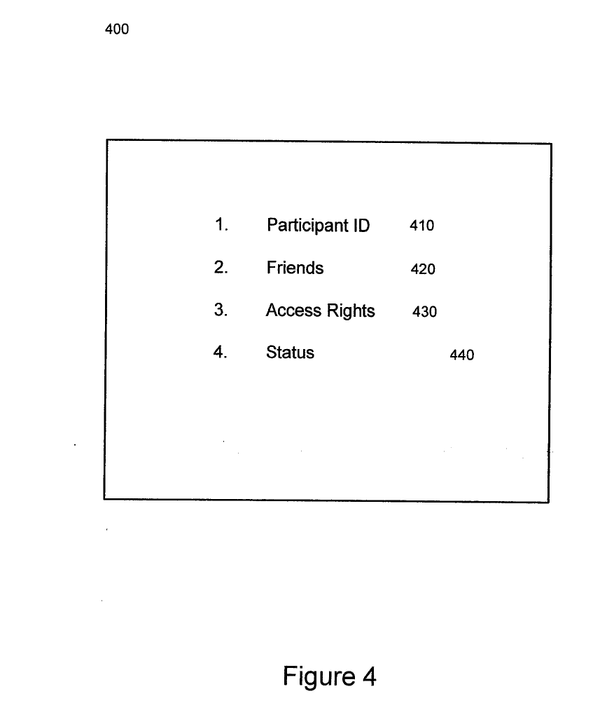

In one embodiment, the storage module 330 stores a record including a profile associated with the each device and/or user. An exemplary profile is shown in a record 400 within FIG. 4.

In one embodiment, the interface module 340 detects input from a user. For example, when a user signs into a profile, the interface module 340 recognizes “friends” or “buddies” of the user from the profile.

In one embodiment, the access module 360 monitors the input from the user through the interface module and selectively allows the user to access other devices based on the profile associated with the user and the profile associated with each device accessed by the user. Further, the access module 360 also selectively allows the user to access selected application(s) on the other devices.

In one embodiment, the application permission module 370 determines whether the application requested through the access module 360 has a proper license to be utilized by the requesting user. For example, an application may be restricted for use at the local site and may not be available for use by remote access. In another example, an application may be restricted for use by a particular user.

In one embodiment, the application permission module 370 selectively allows access to the application requested based on whether the application is available to the user requesting the application. Further in the event that the application is not available to be accessed, the application permission module 370 is configured to secure additional licenses to allow access to the application by the user.

The system 300 in FIG. 3 is shown for exemplary purposes and is merely one embodiment of the methods and apparatuses for utilizing an application on a remote device. Additional modules may be added to the system 300 without departing from the scope of the methods and apparatuses for utilizing an application on a remote device. Similarly, modules may be combined or deleted without departing from the scope of the methods and apparatuses for utilizing an application on a remote device.

FIG. 4 illustrates an exemplary record 400 for use with the methods and apparatuses for utilizing an application on a remote device. In one embodiment, the record 400 illustrates an exemplary record associated with the initiation and participation of a user with a remote device.

In one embodiment, there are multiple records such that each record 400 is associated with a particular user. Further, each user may correspond with multiple records wherein each record 400 is associated with a particular profile associated with the user. In one embodiment, each record 400 is also associated with a particular device.

In one embodiment, the record 400 includes a participant identification field 410, a friends field 420, an access rights field 430, and a status field 440. In one embodiment, the record 400 resides within the client 110. In another embodiment, the record 400 resides within the server 130.

In one embodiment, the participant identification field 410 includes information related to the identity of the user. In one embodiment, the participant identification field 410 comprises an IM identifier associated with the user.

In another embodiment, the participant identification field 410 includes information related to the identity of the device. In one embodiment, the participant identification field 410 comprises a serial number associated with the device.

In one embodiment, the friends field 420 includes a listing of friends or buddies that is associated with the particular profile. For example, if the profile is associated with a particular user, then the listing of friends indicates devices or other users that are associated with the particular user. In some instances, these devices and/or users have allowed the particular user to have access to and control over corresponding devices.

For example, if the profile is associated with a particular device, then the listing of friends indicates devices or other users that are associated with the particular device. In some instances, these devices and/or users have allowed the particular device to have access to and control over corresponding devices.

In one embodiment, the devices listed within the friends field 420 are incorporated within a device list. In one embodiment, this device list represents devices that are available to another device.

In one embodiment, the access rights field 430 designates the type of access and control the user or device associated with the profile has for respective devices associated with the friends field 420.

In one embodiment, the type of access and control rights include viewing content, downloading content, changing configurations, deleting content, adding content, deleting applications, adding applications, modifying applications, and the like.

In another embodiment, the types of applications that can be accessed may also be specified. For example, an Oracle ® application may be specified as the sole application that can be accessed through the remote device. In this case, only documents utilized by the specified Oracle® application on the remote device can be accessed. In one embodiment, multiple applications may be specified.

In another embodiment, a license or restrictions associated with the specific application is stored within the access rights field 430. For example, access limitations due to licensing restrictions may be stored.

In one embodiment, the status field 440 allows a particular device or particular user that is listed within the friends field 420 to have a current status associated with that entity. For example, the status is detected through the device detection module 320. The status includes being available, busy, in a meeting, out to lunch, away from my desk, idle, unavailable, and the like.

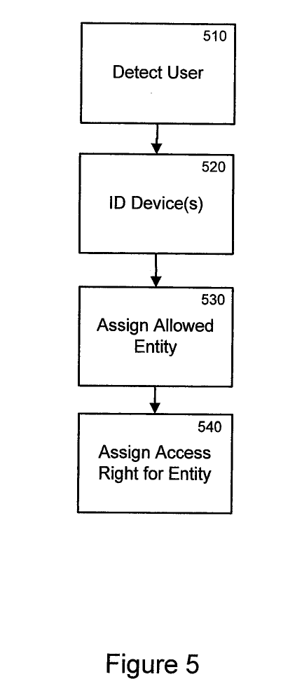

The flow diagrams as depicted in FIGS. 5-9 are one embodiment of the methods and apparatuses for utilizing an application on a remote device. The blocks within the flow diagrams can be performed in a different sequence without departing from the spirit of the methods and apparatuses for communicating between messaging and telephony systems. Further, blocks can be deleted, added, or combined without departing from the spirit of the methods and apparatuses for utilizing an application on a remote device.

The flow diagram in FIG. 5 illustrates forming a profile associated with a user according to one embodiment of the invention.

In Block 510, a user is detected. In one embodiment, the user is identified through a login identification that uniquely identifies that individual user. In another embodiment, the user utilizes a password in conjunction with the login identification to authenticate the user as an authorized party.

In one embodiment, a profile is associated with the user. An exemplary profile is shown as the record 400 in FIG. 4.

In Block 520, a device is identified that is associated with the profile corresponding to the user. In one embodiment, the device is uniquely identified by a descriptive name of the device such as “Dan's computer”, “Laptop computer”, and the like. In another embodiment, the device is uniquely identified by a unique serial number associated with the device. For example, the device may already have a unique serial number assigned at the factory that uniquely identifies that particular device.

In one embodiment, the user has control of the identified device and is able to customize the parties that can access this identified device and limit the type of access to this identified device. For example, the identified device is owned by the user.

In another embodiment, the user has no control of the identified device and utilizes the profile to request access permission from the owner of the identified device.

In Block 530, an entity is assigned access to the identified device referenced in the Block 520. In one embodiment, this entity is a different profile that corresponds to a different user. In another embodiment, this entity is a different profile that corresponds to the same user.

In one embodiment, the entity represents a user that is given access to the identified device when the user owns the identified device. In another embodiment, the entity represents a user that is being asked to give access permission to the user to access the identified device. (more here to explain this relationship)

In Block 540, access rights are assigned to the identified device. In one embodiment, the access rights include viewing content stored on the identified device, downloading content stored on the identified device, modifying content stored on the identified device, deleting content stored on the identified device, adding content onto the identified device, utilizing applications stored on the identified device, downloading applications stored on the identified device, modifying applications stored on the identified device, deleting applications stored on the identified device, and adding applications onto the identified device. In one embodiment, any of these access rights can be assigned to the identified device. Further, particular content and/or applications can be specified to be accessible.

In one embodiment, the access rights are limited based on the number of times the identified device is accessed. For example, the access rights to the identified device are limited to being accessed a predetermined number of times prior to making the identified device inaccessible. In another embodiment, the access rights are limited based on elapsed time. For example, the access rights to the identified device are limited by a predetermined amount of time prior to rendering the identified device inaccessible.

In one embodiment, the access rights are limited to a specific application that resides on the remote device.

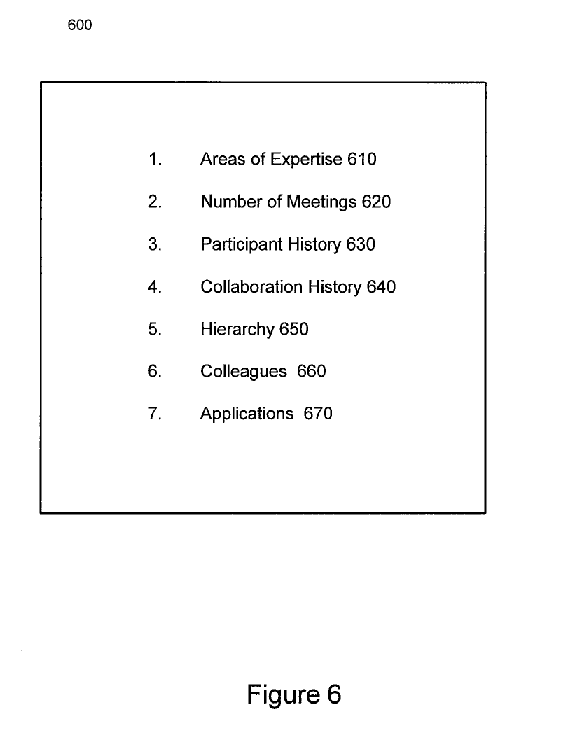

The flow diagram in FIG. 6 illustrates accessing a device according to one embodiment of the invention.

In Block 605, a user accesses a user profile associated with the user. In one embodiment, the user identifies the user profile through a login identification. Further, the user authenticates authorization to the user profile by providing a predetermined password associated with the user profile. In one embodiment, the user may be associated with multiple user profiles.

In Block 610, a device list is displayed. In one embodiment, the device list includes devices that are available to be viewed by the user through the user profile.

In one embodiment, the status of the devices is shown through the device list and represents whether each device is available, unavailable, and the like. In another embodiment, the access rights of each device are also shown through the device list.

In one embodiment, the device list is formatted as a textual list that identifies the identity of the device, the status of each of these device, and the access rights associated with each device.

In another embodiment, the device list is embodied within a graphical user interface that utilizes icons to graphically represent each device shown on the device list, the status of each of these devices, and the access rights associated with each device.

In Block 615, a selected device shown within the device list is selected and an access request is transmitted. In one embodiment, the user associated with the profile chooses the selected device. Further, the user associated with the profile transmits the access request to gain access to the selected device.

In Block 620, a determination is made regarding whether the profile associated with the user is authorized to access the selected device. In one embodiment, a check is performed to ensure that the profile associated with the user is authorized to access the selected device. In one embodiment, the selected device includes an associated profile that lists the authorized profiles that are allowed to access this selected device.

In one embodiment, the user is asked to verify the passwords associated with the profile prior to gaining access to the selected device.

If the profile associated with the user is not authorized to access the selected device, then access to the selected device is denied in Block 625. In one embodiment, when access is denied to the selected device, information is not exchanged between the user associated with the profile and the selected device.

After access is denied in the Block 625, the device list is displayed in the Block 610.

If the profile associated with the user is authorized to access the selected device, then access that is restricted based on the location of the user associated with the profile is checked in Block 630.

If access to the selected device is not restricted based on the location of the user associated with the profile, then access to the selected device is granted to the user in Block 645. In one embodiment, access to the selected device by the user is restricted based on the assigned rights for the particular user and the selected device. In one embodiment, the selected device includes a profile that describes the access rights assigned to particular profiles.

If access to the selected device is restricted based on the location of the user associated with the profile, then the device utilized by the user is detected in Block 635. In one embodiment, the identity of the device utilized by the user is identified through a unique serial number associated with each device.

In one embodiment, the selected device includes a profile that describes the devices that are allowed to access the selected device. For example, in addition to restricting access to the selected device based on the user and the corresponding profile, the selected device may also limit access to the selected device from other predetermined devices. In this case, if the authorized user through the corresponding profile attempts to access the selected device through an unauthorized device, then access to the selected device is denied.

In Block 640, if the device is authorized to access the selected device, then access is allowed based on the assigned rights in the Block 645. If the device is not authorized to access the selected device, then access is denied by the Block 625.

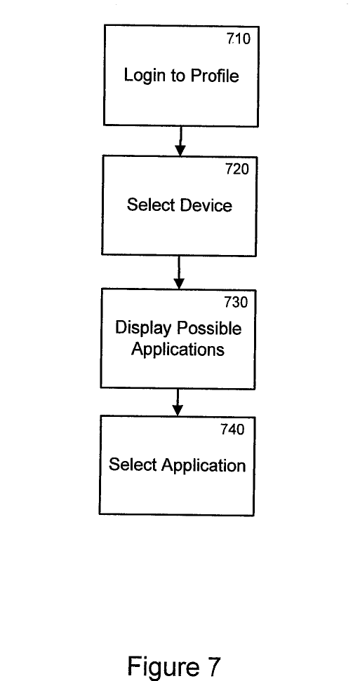

The flow diagram in FIG. 7 illustrates accessing a device according to one embodiment of the invention.

In Block 710, a user accesses a user profile associated with the user. In one embodiment, the user identifies the user profile through a login identification. Further, the user authenticates authorization to the user profile by providing a predetermined password associated with the user profile. In one embodiment, the user may be associated with multiple user profiles.

In Block 720, a device is selected. In one embodiment, a device list is displayed to the user based on the user profile associated with the user.

In Block 730, an application list is presented. In one embodiment, the application list represents a listing of any available applications associated with the device selected in the Block 720. In one embodiment, there are multiple applications within the application list. In another embodiment, there is only one application within the application list.

In Block 740, an application from the application list is selected. The selected application is accessible from the selected device. In one embodiment, content within the selected device is viewable through the selected application. Other content that cannot be utilized through the selected application is not accessible on the selected device. For example, if the selected application is a music player that only works with audio files, then content within the selected device such as text files are not accessible through the selected device. Similarly, if the selected application on the selected device is an Oracle® application that interfaces with data tables, then image files (even stored on the selected device) are not accessible.

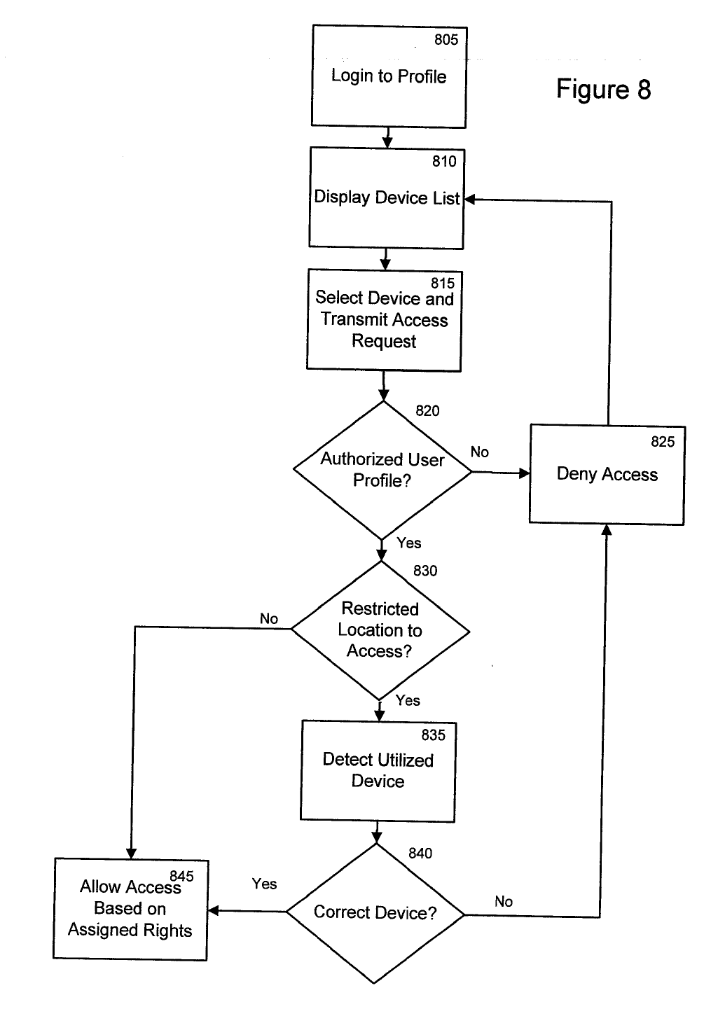

The flow diagram in FIG. 8 illustrates accessing a device according to one embodiment of the invention.

In Block 805, a user accesses a user profile associated with the user. In one embodiment, the user identifies the user profile through a login identification. Further, the user authenticates authorization to the user profile by providing a predetermined password associated with the user profile. In one embodiment, the user may be associated with multiple user profiles.

In Block 810, a device list is displayed. In one embodiment, the device list includes devices that are available to be viewed by the user through the user profile.

In one embodiment, the status of the devices is shown through the device list and represents whether each device is available, unavailable, and the like. In another embodiment, the access rights of each device are also shown through the device list.

In one embodiment, the device list is formatted as a textual list that identifies the identity of the device, the status of each of these device, and the access rights associated with each device.

In another embodiment, the device list is embodied within a graphical user interface that utilizes icons to graphically represent each device shown on the device list, the status of each of these devices, and the access rights associated with each device.

In Block 815, a selected device shown within the device list is selected and an access request is transmitted. In one embodiment, the user associated with the profile chooses the selected device. Further, the user associated with the profile transmits the access request to gain access to the selected device.

In Block 820, a determination is made regarding whether the profile associated with the user is authorized to access the selected device. In one embodiment, a check is performed to ensure that the profile associated with the user is authorized to access the selected device. In one embodiment, the selected device includes an associated profile that lists the authorized profiles that are allowed to access this selected device.

In one embodiment, the user is asked to verify the passwords associated with the profile prior to gaining access to the selected device.

If the profile associated with the user is not authorized to access the selected device, then access to the selected device is denied in Block 825. In one embodiment, when access is denied to the selected device, information is not exchanged between the user associated with the profile and the selected device.

After access is denied in the Block 825, the device list is displayed in the Block 810.

If the profile associated with the user is authorized to access the selected device, then access that is restricted based on the location of the user associated with the profile is checked in Block 830.

If access to the selected device is not restricted based on the location of the user associated with the profile, then access to the selected device is granted to the user in Block 845. In one embodiment, access to the selected device by the user is restricted based on the assigned rights for the particular user and the selected device. In one embodiment, the selected device includes a profile that describes the access rights assigned to particular profiles.

If access to the selected device is restricted based on the location of the user associated with the profile, then the device utilized by the user is detected in Block 835. In one embodiment, the identity of the device utilized by the user is identified through a unique serial number associated with each device.

In one embodiment, the selected device includes a profile that describes the devices that are allowed to access the selected device. For example, in addition to restricting access to the selected device based on the user and the corresponding profile, the selected device may also limit access to the selected device from other predetermined devices. In this case, if the authorized user through the corresponding profile attempts to access the selected device through an unauthorized device, then access to the selected device is denied.

In Block 840, if the device is authorized to access the selected device, then access is allowed based on the assigned rights in the Block 845. If the device is not authorized to access the selected device, then access is denied by the Block 825.

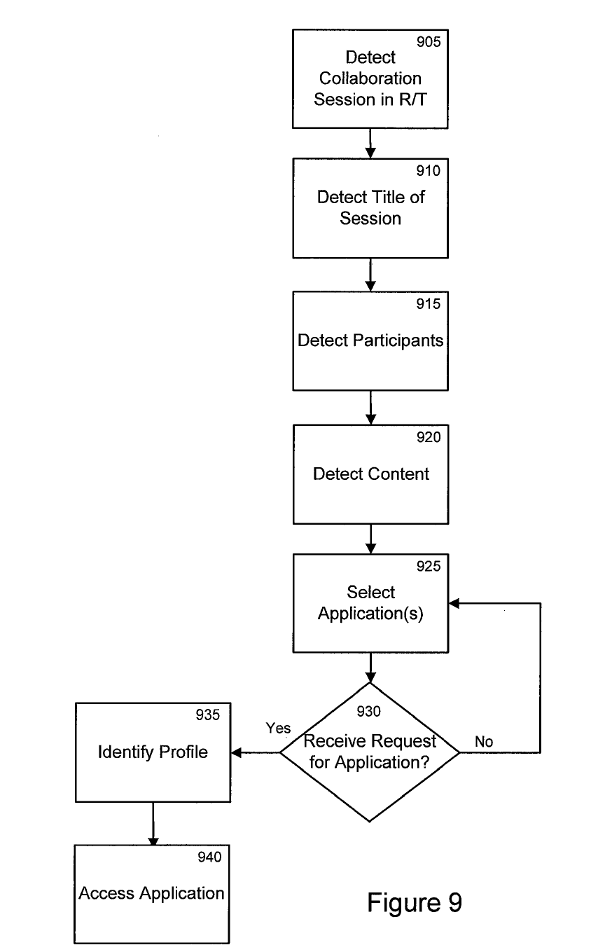

The flow diagram in FIG. 9 illustrates accessing an application according to one embodiment of the invention.

In Block 905, a user accesses a user profile associated with the user. In one embodiment, the user identifies the user profile through a login identification. Further, the user authenticates authorization to the user profile by providing a predetermined password associated with the user profile. In one embodiment, the user may be associated with multiple user profiles.

In Block 910, an application list is displayed. In one embodiment, the application list includes applications that are available to be viewed by the user through the user profile.

In one embodiment, the status of the applications is shown through the application list and represents whether each application is available, unavailable, and the like. In another embodiment, the access rights of each application are also shown through the device list.

In one embodiment, the application list is formatted as a textual list that identifies the identity of the application, the status of each application, and the access rights associated with each application.

In another embodiment, the application list is embodied within a graphical user interface that utilizes icons to graphically represent each application shown on the application list, the status of each of these applications, and the access rights associated with each application.

In Block 915, a selected application shown within the application list is selected and an access request is transmitted. In one embodiment, the user associated with the profile chooses the selected application. Further, the user associated with the profile transmits the access request to gain access to the selected application.

In Block 920, a determination is made regarding whether the profile associated with the user is authorized to access the selected application. In one embodiment, a check is performed to ensure that the profile associated with the user is authorized to access the selected application. In one embodiment, the selected application includes an associated profile that lists the authorized profiles that are allowed to access this selected application.

In one embodiment, the user is asked to verify the passwords associated with the profile prior to gaining access to the selected application.

If the profile associated with the user is not authorized to access the selected application, then access to the selected application is denied in Block 925. In one embodiment, when access is denied to the selected application, information is not exchanged between the user associated with the profile and the selected application.

After access is denied in the Block 925, the application list is displayed in the Block 910.

If the profile associated with the user is authorized to access the selected application, then access that is restricted based on the license or restrictions associated with the selected application is checked in Block 930.

If access to the selected application is not restricted, then access to the selected application is granted to the user in Block 945. In one embodiment, access to the selected application by the user is restricted based on the assigned rights for the particular user and the selected application. In one embodiment, the selected application includes a profile that describes the access rights assigned to particular profiles.

If access to the selected application is restricted based on the license associated with the selected application, then the license associated with the selected application is detected and purchased and/or authorization to access the selected application is attempted in Block 935. In one embodiment, the identity of the device utilized by the user is identified through a unique serial number associated with each device.

In one embodiment, the selected application includes a profile that describes the devices that are allowed to access the selected application. For example, in addition to restricting access to the selected application based on the user and the corresponding profile, the selected application may also limit access based on a number of simultaneous users of the selected application.

In Block 940, if the device is authorized through a valid license to access the selected application, then access is allowed based in the Block 945. If the device is not authorized to access the selected application, then access is denied by the Block 925.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
displaying a list representing a plurality of applications;
viewing a status of each of the plurality of applications;
viewing a target application as an available application from the plurality of applications;
remotely accessing the target application on a local device.

2. The method according to claim 1 wherein each of the plurality of applications is associated with a target device.

3. The method according to claim 2 wherein the target device is one of a computer, a telephone, a personal digital assistant, and a pager.

4. The method according to claim 2 further comprising viewing a plurality of applications accessible on the target device.

5. The method according to claim 1 wherein the local device is one of a computer, a telephone, a personal digital assistant, and a pager.

6. The method according to claim 1 further comprising authenticating an identity of a user of the local device.

7. The method according to claim 1 further comprising selecting the target application from the plurality of applications.

8. The method according to claim 1 further comprising displaying a plurality of content accessible on a target device wherein the plurality of content is compatible with the target application.

9. A method comprising:
selecting an application located on a target device;
determining an availability of the application accessed on a local device; and
selectively securing a license to access the application on the local device based on the availability.

10. The method according to claim 9 wherein the application is one of a word processor program, a spreadsheet program, an imaging program, a database program, an audio program, and an electronic mail program.

11. The method according to claim 9 further comprising recognizing content on the target device associated with the application.

12. The method according to claim 9 further comprising accessing content associated with the application on the local device.

13. The method according to claim 9 wherein securing the license further comprises purchasing an additional license to accommodate remote access of the application.

14. The method according to claim 9 wherein securing the license further comprises purchasing an additional license to accommodate remote access of the application.

15. A system, comprising:
a profile manager module configured to track a device profile wherein the device profile includes an assigned application for a corresponding device;
an access module configured to selectively control access to the assigned application based on a restriction of the assigned application; and
an interface module configured to display a representation of the assigned application.

16. The system according to claim 15 wherein the assigned application is one of a word processor program, a spreadsheet program, an imaging program, a database program, an audio program, and an electronic mail program.

17. The system according to claim 15 further comprising a storage module configured to store the device profile.

18. The system according to claim 15 further comprising a device detection module configured for detecting a status of a device associated with the assigned application.

19. The system according to claim 15 where the restriction is based on a number of users simultaneously viewing the assigned application.

20. The system according to claim 15 where the restriction is based on a remote access of the assigned application.

21. The system according to claim 15 wherein the interface module is further configured to display the assigned application.

22. The system according to claim 15 wherein the interface module is further configured to display content associated with the assigned application.
